(19) United States
(12) Patent Application Publication
(10) Pub. No.: US 2024/0129362 A1
(43) Pub. Date: Apr. 18, 2024

(54) LATENCY CONTROL APPARATUS, LATENCY CONTROL METHOD AND LATENCY CONTROL PROGRAM

(71) Applicant: Nippon Telegraph and Telephone Corporation, Tokyo (JP)

(72) Inventors: Mitsuo AMASAKA, Musashino-shi, Tokyo (JP); Takamitsu NARUMI, Musashino-shi, Tokyo (JP); Takayuki NAKAMURA, Musashino-shi, Tokyo (JP); Takuya SATO, Musashino-shi, Tokyo (JP)

(21) Appl. No.: 18/276,921

(22) PCT Filed: Feb. 15, 2021
(86) PCT No.: PCT/JP2021/005577

§ 371 Date: Aug. 11, 2023

(51) Int. Cl. H04L 67/101

(52) U.S. Cl. CPC H04L 67/101

(57) ABSTRACT

An orchestrator locates a server in anyone of a plurality of edge clouds on the basis of a plurality of delay differences, respectively corresponding to the plurality of the edge clouds having each delay difference and assumed if the server located in each of the edge clouds, that are each a difference between delay from the server to a first client and delay from the server to a second client, and gives a delay to at least one of the first client and the second client so that the delay from the located server to the first client and the delay from the located server to the second client become the same.

### TECHNICAL FIELD

The present disclosure relates to a delay control device, a delay control method, and a delay control program.

### BACKGROUND ART

From the beginning of the 2000 age, the cloud game started. Cloud games are known as services for distributing computer games by streaming. In the cloud game, a stationary machine is not required, and a player can play the game without being affected by the device specification. From such a merit, the cloud game is attracting attention.

In the cloud game, the data processing is aggregated on the server side compared with the online game. Therefore, the cloud game can be more easily managed in operation. On the other hand, a major problem of a cloud game is an influence of infrastructure costs and delay.

Among them, it is difficult to solve the problem related to the influence of delay. In a game title requiring a low delay, it may be difficult to provide the game title as a cloud game. In particular, in the competition type game title, the difference in delay performance between players is directly connected to the advantage and disadvantage of the game. Therefore, it is considered desirable for players with low delay and comparable latency performance to play against each other.

In order to solve such a problem related to the influence of delay, various techniques have been proposed.

For example, it has been proposed to select a location where a server is located with a minimum delay for a plurality of clients (see, for example, NPL 1). This selection method can select a server in which the delay amount is comprehensively reduced in consideration of the delay amount of all clients.

Also, it has been proposed that a general shaping function is utilized for packet transfer to make the communication delay within a certain range (see, for example, PTL 1). In a method for making the communication delay within a certain range, delay fluctuation in a certain section can be reduced, and communication delay of a single communication can be guaranteed.

### CITATION LIST

### Patent Literature

[PTL 1] Japanese Patent Application Laid-open No. 2019-118072

### Non Patent Literature

[NPL 1] Takuya Satou, four others, “Proposal of a method for selecting server deployment locations when using real-time communication applications”, proceedings of IEICE General Conference, B-6-29, March, 2019.

### SUMMARY OF INVENTION

### Technical Problem

However, the above-described conventional technique may not be able to ensure fairness of delay.

For example, with respect to the NPL 1, a method for selecting a location where a server is located requires some mechanism for absorbing a difference in each delay performance in order to ensure higher fairness for small numbers of users.

In the PTL 1, the method of making the communication delay within a certain range does not make communication quality at two points align or can control the delay performance of the user section. Therefore, in this method, it is difficult to ensure the fairness of communication by E2E (End To End).

The present application has been made in view of the above, and an object thereof is to ensure fairness of delay.

### Solution to Problem

A delay control device according to an embodiment of the present disclosure includes a location unit that locates a server in anyone of a plurality of edge clouds on the basis of a plurality of delay differences, respectively corresponding to the plurality of the edge clouds having each delay difference and assumed if the server located in each of the edge clouds, that are each a difference between delay from the server to a first client and delay from the server to a second client, and a giving unit for giving a delay to at least one of the first client and the second client so that the delay from the server located by the location unit to the first client and the delay from the server located by the location unit to the second client become the same.

### Advantageous Effects of Invention

According to an aspect of an embodiment, it is possible to ensure fairness of delay.

### BRIEF DESCRIPTION OF DRAWINGS

FIG. 1 is a diagram showing an example of a configuration of a delay control system according to an embodiment.

FIG. 2 is a diagram showing an example of a configuration of a network according to an embodiment.

FIG. 3A is an explanatory diagram showing an outline of delay control processing according to an embodiment.

FIG. 3B is an explanatory diagram showing an outline of delay control processing according to an embodiment.

FIG. 3C is an explanatory diagram showing an outline of delay control processing according to an embodiment.

FIG. 4 is a diagram showing an example of a configuration of an orchestrator according to an embodiment.

FIG. 5 is a diagram showing an example of a configuration of a controller according to an embodiment.

FIG. 6 is a diagram showing an example of a configuration of the SLG according to an embodiment.

FIG. 7 is a diagram showing an example of a configuration of a game server according to an embodiment.

FIG. 8 is a diagram showing an example of a configuration of a user device according to an embodiment.

FIG. 9A is an explanatory diagram showing an example of delay control processing according to an embodiment.

FIG. 9B is an explanatory diagram showing an example of delay control processing according to an embodiment.

FIG. 9C is an explanatory diagram showing an example of delay control processing according to an embodiment.

FIG. 10 is a flowchart showing an example of processing executed by the orchestrator according to an embodiment to eliminate a delay difference while suppressing a delay.

FIG. 11 is a diagram showing another example of a configuration of the orchestrator according to an embodiment.

FIG. 12 is a flowchart showing an example of a procedure of the additional delay control processing according to an embodiment.

FIG. 13 is an explanatory diagram showing an example of the additional delay control processing according to an embodiment.

FIG. 14 is a diagram showing an example of a hardware configuration.

### DESCRIPTION OF EMBODIMENTS

Hereinafter, an embodiment of the present disclosure will be described in detail with reference to the drawings. Note that this embodiment is not intended to limit the scope of the present invention. Details of one or more embodiments are described in the following description and drawings. Further, the plurality of embodiments can be appropriately combined within a range in which the processing contents are not contradictory to each other. In the following one or more embodiments, the same parts are denoted by the same reference signs, and redundant description is omitted.

### 1. First

Conventionally, in order to reduce a delay between a plurality of users (that is, a plurality of clients) in a network and a server in a cloud environment, it has been proposed to locate a server in an edge cloud near a client (for example, see NPL 1 described above).

However, the server is located so that the delay amounts of all clients are comprehensively reduced. Therefore, in the location method as described above, it is difficult to strictly reduce a delay difference among small numbers of users, such as a delay difference in a battle-type online game.

Therefore, the orchestrator according to the embodiment performs delay control processing described below in order to ensure fairness of services among small numbers of users.

### 2. Configuration of Delay Control System

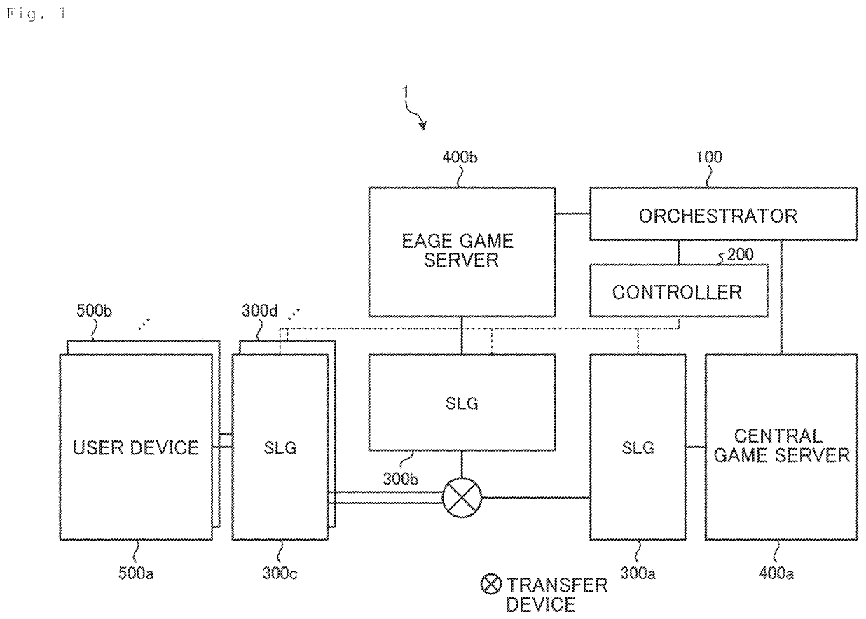

A delay control system according to the present embodiment will be described with reference to FIG. 1.

FIG. 1 is a diagram showing an example of a configuration of a delay control system 1 according to an embodiment. As shown in FIG. 1, the delay control system 1 includes an orchestrator 100, a controller 200, an SLG 300a, SLG 300b, SLG 300c, SLG 300d, a central game server 400a, an edge game server 400b, a user device 500a and a user device 500b are included.

Although not shown in FIG. 1, the delay control system 1 may include a plurality of orchestrators 100 and a plurality of controllers 200.

In the present specification, if it is not necessary to distinguish between SLG 300a to SLG 300d, SLG 300a to SLG 300d are collectively referred to as SLG 300. When it is not necessary to distinguish the central game server 400a and the edge game server 400b, the central game server 400a and the edge game server 400b are collectively referred the game server 400. When it is not necessary to distinguish the user device 500a from the user device 500b, the user device 500a and the user device 500b are collectively referred to as the user device 500.

In the delay control system 1, the orchestrator 100, the controller 200, the SLG 300, the game server 400, and the user device 500 can communicate with each other via a network such as the Internet, a wide area network (WAN), or a local area network (LAN).

The orchestrator 100 is an information processing device that manages and controls the controller 200. In order to ensure fairness of services (for example, cloud games) among small numbers of users, the orchestrator 100 performs delay control processing. The delay control processing is a process of controlling a delay in a network. The outline of the delay control processing is described in Chapter 3. The orchestrator 100 may be any type of information processing device including a server. An example of the configuration of orchestrator 100 is described in detail in Chapter 4.

The controller 200 is an information processing device that manages the SLG 300. The controller 200 may be any type of information processing device including a server. An example of the configuration of the controller 200 is detailed in Chapter 5.

The SLG 300 is a Slice Gateway (SLG) for controlling packet transfer. The SLG 300 may be any type of information processing device including a server. An example of the configuration of the SLG 300 is described in detail in Chapter 6.

The game server 400 is an information processing device that provides a cloud game. The game server 400 may be any type of information processing device including a server. An example of the configuration of the game server 400 is described in detail in Chapter 7.

The user device 500 is an information processing device used by a user of a cloud game. The user device 500 may be any type of information processing device including a client device. An example of a configuration of the user device 500 is described in detail in Chapter 8.

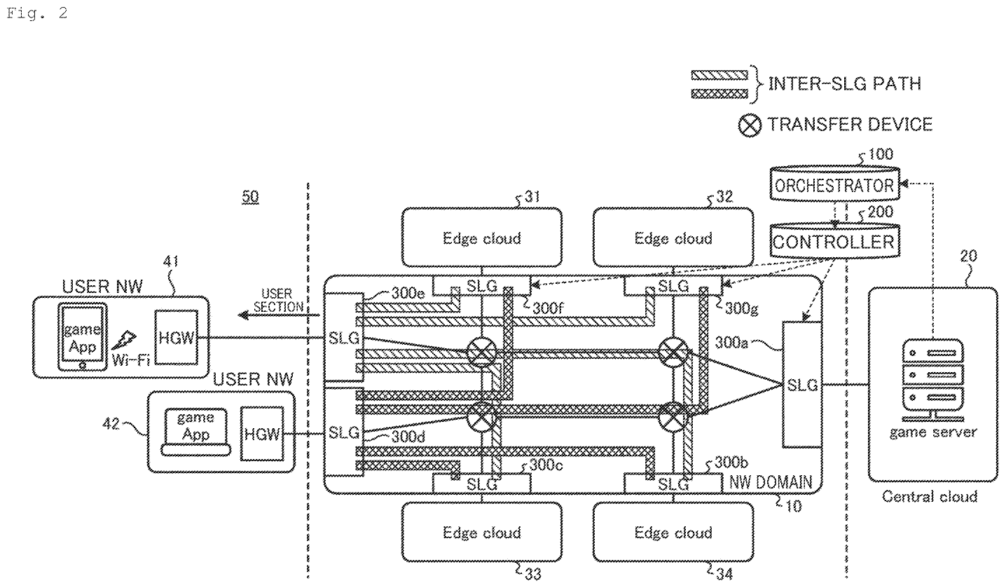

FIG. 2 is a diagram showing an example of a configuration of a network according to the embodiment. The network according to the embodiment includes a NW (network) domain 10, a central cloud 20, an edge cloud 31, an edge cloud 32, an edge cloud 33, an edge cloud 34, a user NW (network) 41, and a user NW 42. The network according to the embodiment includes an inter-SLG path and a transfer device.

The NW domain 10 includes SLG 300a to SLG 300g. In the NW domain 10, SLG 300a to SLG 300g are used for transfer control. In the central cloud 20, a game server is deployed. The user NW 41 and the user NW 41 correspond to the user section 50.

The environment in the user NW is different for each user. Therefore, the delay generated in the user NW 41 is different from the delay generated in the user NW 42.

The inter-SLG path is a path (priority control path) that is preferentially controlled. In the NW domain 10, a preferentially controlled path is established. Each SLG acquires a delay amount in a path as telemetry information.

The orchestrator 100 transmits various instructions to the SLG via the controller 200. The game server on the central cloud transmits various instructions to the orchestrator 100.

### 3. Outline of Delay Control Processing

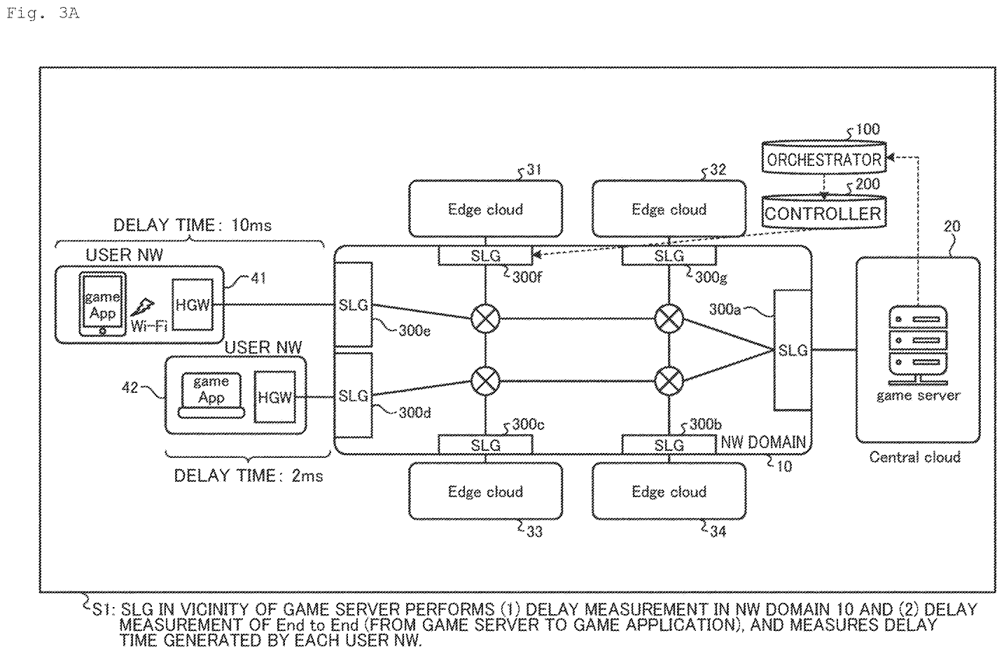

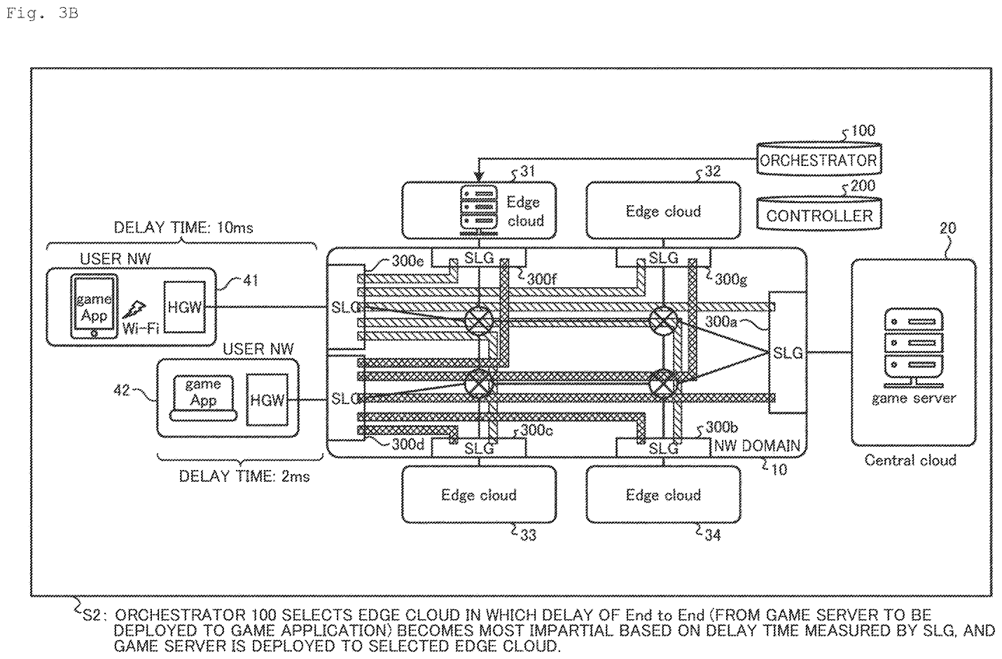

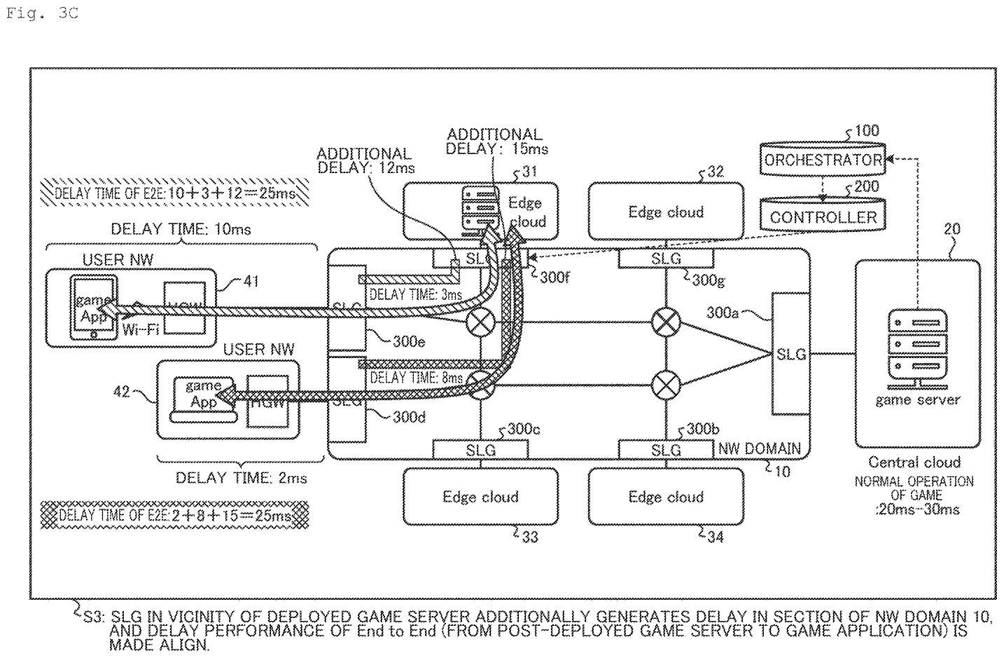

Next, an outline of the delay control processing will be described with reference to FIGS. 3A, 3B, and 3C. This outline is not intended to limit the present invention and the embodiments described in the following sections.

FIGS. 3A, 3B, and 3C are diagrams showing an outline of delay control processing according to the embodiment.

Referring to FIG. 3A, first, the SLG in the vicinity of the game server performs (1) delay measurement in the NW domain 10 and (2) delay measurement of E2E (from the game server to the game application), and measures delay time generated by each user NW (step S1). In the example of FIG. 3A, the delay time generated in the user NW 41 is 10 ms. On the other hand, the delay time generated in the user NW 42 is 2 ms.

Referring to FIG. 3B, an orchestrator 100 then selects an edge cloud in which the delay of E2E (from a game server to be deployed to a game application) becomes the most impartial based on the delay time measured by the SLG, and the game server is deployed to the selected edge cloud (step S2). In the example of FIG. 3B, the orchestrator 100 deploys the game server to the edge cloud 31.

Referring to FIG. 3C, the SLG in the vicinity of the deployed game server then additionally generates a delay in the section of the NW domain 10, and the delay performance of the E2E (from the post-deployed game server to the game application) is made align (step S3). The orchestrator 100 may instruct the SLG300f to delay the target packet via the controller 200. In the example of FIG. 3C, SLG 300f aligns the delay time of each E2E to 25 ms. For example, the SLG 300f gives a delay to a target packet by queuing or the like.

As described above, the orchestrator 100 deploys the game server to a location where a delay difference in E2E is small for two applications whose locations are different from each other. Then, the SLG 300 located in the vicinity of the location where the delay difference in E2E is small aligns the delay difference in E2E with a fair delay time.

With respect to communication between the game server and applications of two bases different in location, the orchestrator 100 can minimize delay performance in E2E and achieve the same delay performance. Therefore, the orchestrator 100 can ensure fairness of the service.

### 4. Configuration of Orchestrator

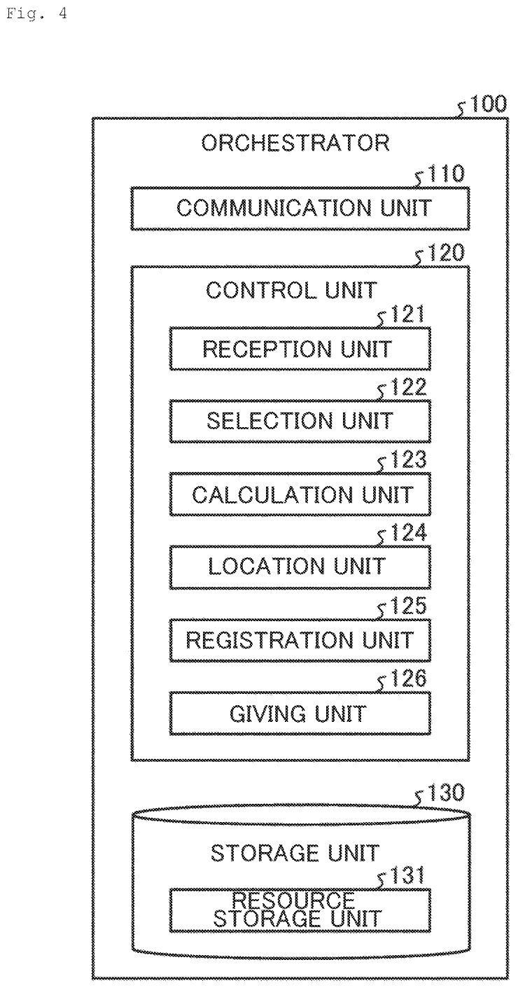

Next, an example of the configuration of the orchestrator 100 will be described with reference to FIG. 4.

FIG. 4 is a diagram showing an example of a configuration of an orchestrator according to the embodiment. As shown in FIG. 4, the orchestrator 100 includes a communication unit 110, a control unit 120, and a storage unit 130. The orchestrator 100 may include an input unit (for example, a keyboard, a mouse, or the like) that receives various operations from an administrator or the like who uses the orchestrator 100, and a display unit (organic EL (Electro Luminescence), liquid crystal display, or the like) that displays various types of information.

(Communication Unit 110)

The communication unit 110 is realized by, for example, an NIC (Network Interface Card). The communication unit 110 is connected to a network by wire or wirelessly. The communication unit 110 may be communicably connected to the controller 200, the SLG 300, the game server 400, and the user device 500 via a network. The communication unit 110 can transmit and receive information via a network.

(Control Unit 120)

The control unit 120 is a controller (control device). The control unit 120, for example, uses RAM (Random Access Memory), or the like as a work area and is implemented by a processor such as a CPU (Central Processing Unit), MPU (Micro Processing Unit), and the like that executes various programs (corresponding to an example of a delay control program) stored in a memory device inside the orchestrator 100. Further, the control unit 120 is realized by an integrated circuit, for example, such as an ASIC (Application Specific Integrated Circuit), FPGA (Field Programmable Gate Array), GPGPU (General Purpose Graphic Processing Unit), or the like. As illustrated in FIG. 4, the control unit 120 includes a reception unit 121, a selection unit 122, a calculation unit 123, a location unit 124, a registration unit 125, and a giving unit 126, and realizes or executes functions and actions of information processing described below. The one or more processors of the orchestrator 100 may implement the functions of each control unit in the control unit 120 by executing instructions stored in the one or more memories of the orchestrator 100. The internal configuration of the control unit 120 is not limited to the configuration illustrated in FIG. 4, and the internal configuration of the control unit 120 may be another configuration that performs information processing described later. For example, the giving unit 126 may perform all or a part of information processing described later with respect to a unit other than the giving unit 126.

(Reception Unit 121)

The reception unit 121 has an information reception function. The reception unit 121 receives various information from a controller 200 and a game server 400. A reception unit 121 receives the results of the test and measurement from the device to be managed. The device to be managed is, for example, a controller 200.

The reception unit 121 receives the delay time from the controller 200. For example, the reception unit 121 receives the E2E delay time for each candidate location of the edge cloud.

(Selection Unit 122)

The selection unit 122 has an edge cloud determination function. A selection unit 122 selects an edge cloud.

The selection unit 122 selects a candidate location where the server is deployed from the plurality of edge clouds on the basis of the E2E delay time received by the reception unit 121. For example, the selection unit 122 selects a candidate location in which the E2E delay time is within a range in which the game normally operates.

(Calculation Unit 123)

The calculation unit 123 has a delay difference calculation function. The calculation required for the deployment of the server is performed on the basis of information such as the delay amount.

A calculation unit 123 calculates a difference in delay time for each candidate location selected by the selection unit 122. The difference of the delay time is, for example, a difference between the delay time of the user device 500a and the delay time of the user device 500b.

(Location Unit 124)

The location unit 124 has a deployment function. A location unit 124 deploys the game server to the edge cloud selected by the selection unit 122. For example, the location unit 124 instructs the edge cloud selected by the selection unit 122 to deploy the game server.

The location unit 124 locates the server in one of the plurality of edge clouds on the basis of the plurality of delay differences. The plurality of delay differences respectively correspond to the plurality of edge clouds. Each delay difference is a difference between a delay from the server to the first client and a delay from the server to the second client, which is assumed when the server is allocated in an individual edge cloud.

For example, the location unit 124 locates the server in one of the plurality of edge clouds so as to minimize a difference between a delay from the server to the first client and a delay from the server to the second client.

(Registration Unit 125)

A registration unit 125 registers information on the game server deployed by the location unit 124. For example, the registration unit 125 registers a new flow. The new flow is communication of new E2E. That is, the new flow is the communication between the deployed game server and the user device 500. The registration unit 125 may store the information related to the deployed game server in a resource storage unit 131 to be described later.

(Giving Unit 126)

The giving unit 126 has an information transmission function. The giving unit 126 transmits an instruction to a device to be managed.

The giving unit 126 additionally gives delay to the section of the E2E so as to eliminate the difference of the delay time. Specifically, the giving unit 126 instructs the SLG 300 to give a delay to a packet of the user device 500. The instruction is transmitted from the giving unit 126 to the SLG 300 via the controller 200.

(Storage Unit 130)

The storage unit 130 is realized by, for example, a semiconductor memory element such as a RAM or a flash memory (flash memory), or a storage device such as a hard disk or an optical disk. As shown in FIG. 4, the storage unit 130 has a resource storage unit 131.

(Resource Storage Unit 131)

The resource storage unit 131 stores various resources. The resource storage unit 131 has a resource management function.

The resource storage unit 131 holds telemetry information as various resources. For example, the telemetry information includes telemetry information between SLG (for example, SLG 300a) and SLG (for example, SLG 300b) acquired by SLG 300, telemetry information (for example, delay time, bandwidth, and packet loss rate) between the SLG 300 and the game server 400, and the like.

The various resources include information of an edge cloud and a central cloud. The various resources include telemetry information such as information of the SLG 300 connected to the target candidate location and connection information between the SLG (for example, the SLG 300a) and the SLG (for example, the SLG 300b).

The various resources include information on a user device 500 and a group to which the user device 500 belongs.

The various resources include a scenario for converting various settings into information required for controlling the network. For example, the various resources include a scenario for converting various settings for each service level requested by the game server 400. Various settings are, for example, the game server 400 of a connection destination.

### 5. Configuration of Controller

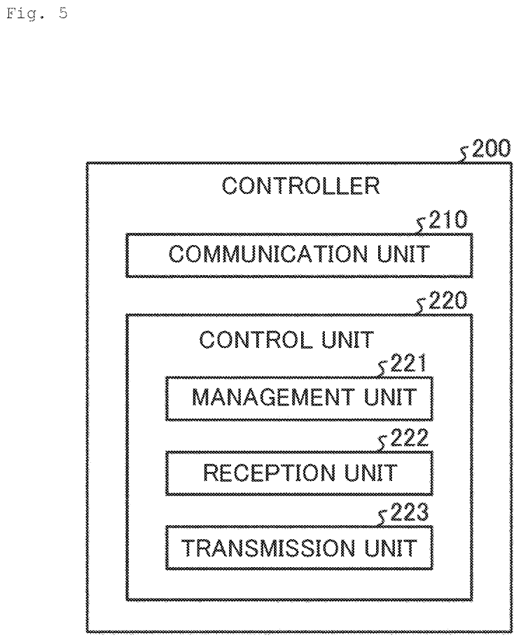

Next, an example of the configuration of the controller 200 will be described with reference to FIG. 5.

FIG. 5 is a diagram showing an example of a configuration of the controller 200 according to the embodiment. As shown in FIG. 5, the controller 200 includes a communication unit 210 and a control unit 220. The controller 200 may include an input unit (for example, keyboard, mouse, or the like) that receives various operations from an administrator or the like who uses the controller 200 and a display unit (organic EL, liquid crystal display, or the like) that displays various types of information.

(Communication Unit 210)

The communication unit 210 is implemented by, for example, an NIC or the like. The communication unit 210 is connected to a network by wire or wirelessly. The communication unit 210 may be communicably connected to the orchestrator 100, the SLG 300, the game server 400, and the user device 500 via a network. The communication unit 210 can transmit and receive information via a network.

(Control Unit 220)

The control unit 220 is a controller. The control unit 220 uses, for example, a RAM or the like as a work area, and is realized by a processor such as a CPU or an MPU that executes various programs stored in a storage device inside the controller 200. Further, the control unit 220 includes, for example, an ASIC, an FPGA, it may be realized by an integrated circuit such as a GPGPU.

As illustrated in FIG. 5, the control unit 220 includes a management unit 221, a reception unit 222, and a transmission unit 223, and realizes or executes functions and actions of information processing described below. The one or more processors of the controller 200 may implement the functions of the each control unit in the control unit 220 by executing instructions stored in the one or more memories of the controller 200. The internal configuration of the control unit 220 is not limited to the configuration illustrated in FIG. 5, and the internal configuration of the control unit 220 may be another configuration that performs information processing described later. For example, the management unit 221 may perform all or a part of information processing described later with respect to units other than the management unit 221.

(Management Unit 221)

The management unit 221 has an SLG management function. The management unit 221 transmits the instruction transmitted from the giving unit 126 of the orchestrator 100 to the SLG 300. Specifically, the instruction is transmitted to a command for controlling the SLG 300.

The management unit 221 also sets information on a path of an allocation destination of a packet. The management unit 221 transmits information on the path to the SLG 300.

(Reception Unit 222)

The reception unit 222 has an information reception function. The reception unit 222 receives various information (for example, instructions) from the orchestrator 100. The reception unit 222 receives various information (e.g. telemetry information) from the SLG 300.

(Transmission Unit 223)

The transmission unit 223 has an information transmission function. A transmission unit 223 transmits various information to the orchestrator 100 and the SLG 300. For example, the transmission unit 223 transmits information (e.g., telemetry information) transmitted from the SLG 300 to the orchestrator 100.

### 6. Configuration of SLG

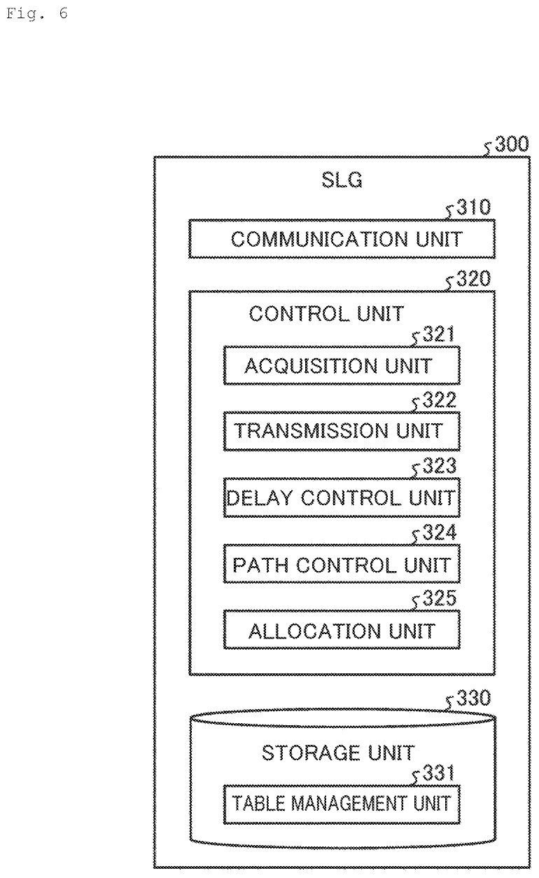

Next, an example of the configuration of the SLG 300 will be described with reference to FIG. 6.

FIG. 6 is a diagram showing an example of a configuration of the SLG 300 according to the embodiment. As shown in FIG. 6, the SLG 300 includes a communication unit 310, a control unit 320, and storage unit 330. The SLG 300 may include an input unit (for example, keyboard, mouse, or the like) that receives various operations from an administrator or the like who uses the SLG 300 and a display unit (organic EL, liquid crystal display, or the like) that displays various types of information.

(Communication Unit 310)

The communication unit 310 is implemented by, for example, an NIC or the like. The communication unit 310 is connected to a network by wire or wirelessly. The communication unit 310 may be communicably connected to the orchestrator 100, the controller 200, the game server 400, and the user device 500 via a network. The communication unit 310 can transmit and receive information via a network.

(Control Unit 320)

The control unit 320 is a controller. The control unit 320 uses, for example, a RAM or the like as a work area, and is realized by a processor such as a CPU or an MPU that executes various programs stored in a storage device inside the SLG 300. Further, the control unit 320 includes, for example, an ASIC, an FPGA, it may be realized by an integrated circuit such as a GPGPU.

As shown in FIG. 6, the control unit 320 includes an acquisition unit 321, a transmission unit 322, a delay control unit 323, a path control unit 324, and an allocation unit 325, and realizes or executes functions and actions of information processing described below. The one or more processors of the SLG 300 may implement the functions of the each control unit in the control unit 320 by executing instructions stored in the one or more memories of the SLG 300. The internal configuration of the control unit 320 is not limited to the configuration illustrated in FIG. 6, and the internal configuration of the control unit 320 may be another configuration that performs information processing described later. For example, the delay control unit 323 may perform all or a part of information processing described later with respect to units other than the delay control unit 323.

(Acquisition Unit 321)

The acquisition unit 321 has an information acquisition function. The acquisition unit 321 acquires various types of information. For example, the acquisition unit 321 acquires telemetry information.

The acquisition unit 321 acquires telemetry information (for example, delay time, bandwidth, and packet loss rate) in units of paths between SLG (for example, SLG 300a) and SLG (for example, SLG 300b). When the SLG 300 is in the vicinity of the game server 400, an acquisition unit 321 of the SLG 300 acquires telemetry information between the SLG 300 and the user device 500. Further, the acquisition unit 321 acquires telemetry information between the SLG 300 and the game server 400.

(Transmission Unit 322)

The transmission unit 322 has an information transmission function. The transmission unit 322 transmits various kinds of information. For example, the transmission unit 322 transmits the telemetry information acquired by the acquisition unit 321 to the controller 200.

(Delay Control Unit 323)

The delay control unit 323 has a delay control function. A delay control unit 323 imparts a delay time to the packet. For example, in response to reception of an instruction from the controller 200, the packet of 5-tuples corresponding to the instruction is intentionally performed queuing. In this way, the delay control unit 323 gives the delay time to the corresponding 5-tuples packet.

(Path Control Unit 324)

The path control unit 324 has a path control function. For example, the path control unit 324 performs termination processing of a path between SLG (for example, SLG300a) and SLG (for example, SLG300b). The path termination processing is the addition and deletion of a tunnel header. When a packet to a target path is output, the path control unit 324 performs priority control and band control in accordance with a set value of the path. Thus, the path control unit 324 generates a plurality of paths whose communication requirements are different from each other.

(Allocation Unit 325)

The allocation unit 325 has a packet allocation function. The allocation unit 325 outputs the input packet to the target path on the basis of the information on the path stored in the table management unit 331 which will be described later. The allocation unit 325 may receive information on the path from the management unit 221 of the controller 200. The allocation unit 325 may store the information on the path in the table management unit 331.

(Storage Unit 330)

The storage unit 330 is realized by, for example, a semiconductor memory element such as a RAM or a flash memory, or a storage device such as a hard disk or an optical disk. As shown in FIG. 6, the storage unit 330 has a table management unit 331.

(Table Management Unit 331)

The table management unit 331 has a flow table management function. For example, the table management unit 331 stores information on a path of a packet allocation destination. The information on the path of the packet allocation destination is set by the management unit 221 of the controller 200, for example. The information on the path of the allocation destination of the packet corresponds to the 5-tuples packet.

### 7. Configuration of Game Server

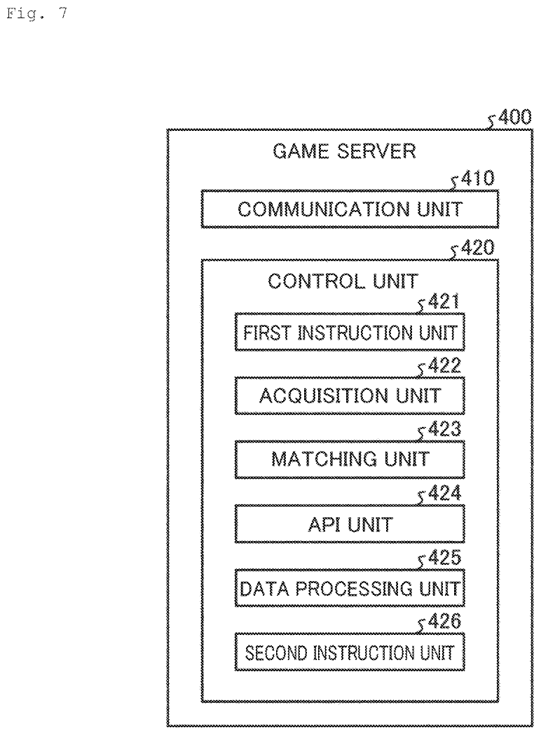

Next, an example of the configuration of the game server 400 will be described with reference to FIG. 7.

FIG. 7 is a diagram showing an example of a configuration of the game server 400 according to the embodiment. As shown in FIG. 7, the game server 400 includes a communication unit 410 and a control unit 420. The game server 400 may include an input unit (for example, keyboard, mouse, or the like) that receives various operations from an administrator or the like who uses the game server 400 and a display unit (organic EL, liquid crystal display, or the like) that displays various types of information.

(Communication Unit 410)

The communication unit 410 is implemented by, for example, an NIC or the like. The communication unit 410 is connected to a network by wire or wirelessly. The communication unit 410 may be communicably connected to the orchestrator 100, the controller 200, the SLG 300, and the user device 500 via a network. The communication unit 410 can transmit and receive information via a network.

(Control Unit 420)

The control unit 420 is a controller. The control unit 420 uses, for example, a RAM or the like as a work area, and is realized by a processor such as a CPU or an MPU that executes various programs stored in a storage device inside the game server 400. Further, the control unit 420 includes, for example, an ASIC, an FPGA, it may be realized by an integrated circuit such as a GPGPU.

As shown in FIG. 7, the control unit 420 has the first instruction unit 421, the acquisition unit 422, the matching unit 423, the API unit 424, the data processing unit 425, and the second instruction unit 426, and realizes or executes the function and action of the information processing described below. The one or more processors of the game server 400 may implement the functions of the each control unit in the control unit 420 by executing commands stored in the one or more memories of the game server 400. The internal configuration of the control unit 420 is not limited to the configuration illustrated in FIG. 7, and the internal configuration of the control unit 420 may be another configuration that performs information processing described later. For example, the first instruction unit 421 may perform all or part of the information processing mentioned later about the part other than the first instruction unit 421.

(First Instruction Unit 421)

The first instruction unit 421 has an instruction function. The first instruction unit 421 instructs the SLG 300 to measure the delay time of the E2E. For example, a first instruction unit 421 of a game server 400 of a central cloud transmits an instruction to an SLG 300 via an orchestrator 100.

(Acquisition Unit 422)

The acquisition unit 422 has an information acquisition function. The acquisition unit 422 acquires various types of information from the orchestrator 100 or the SLG 300. For example, the acquisition unit 422 acquires delay information via the orchestrator 100.

(Matching Unit 423)

The matching unit 423 has a packet matching function. A matching unit 423 detects connection of applications for two users. The matching unit 423 acquires information on two users.

(API Unit 424)

The API unit 424 has an API function. The API unit 424 collects the information of the two users acquired by the matching unit 423, and transmits the collected information to the orchestrator 100.

(Data Processing Unit 425)

The data processing unit 425 has a data processing function. A data processing unit 425 controls transmission and reception of packets between two users. A data processing unit 425 performs processing required for executing the game. For example, the data processing unit 425 performs processing such as processing of logical data, processing of polygon data, and drawing processing in an application.

(Second Instruction Unit 426)

The second instruction unit 426 has an instruction function. A second instruction unit 426 instructs the orchestrator 100 to register a new flow. For example, a second instruction unit 426 of a game server 400 of an edge cloud transmits an instruction to the orchestrator 100.

### 8. Configuration of User Device

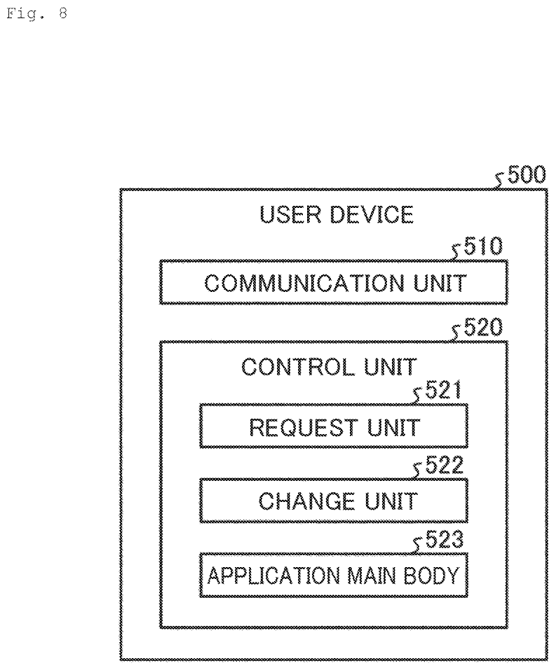

Next, an example of a configuration of the user device 500 will be described with reference to FIG. 8.

FIG. 8 is a diagram showing an example of a configuration of the user device 500 according to the embodiment. As shown in FIG. 8, the user device 500 includes a communication unit 510 and a control unit 520. The user device 500 may include an input unit (for example, keyboard, mouse, or the like) that receives various operations from a user or the like who uses the user device 500 and a display unit (organic EL, liquid crystal display, or the like) that displays various types of information. When a touch panel is employed in the user device 500, the input unit and the output unit are integrated.

(Communication Unit 510)

The communication unit 510 is implemented by, for example, an NIC or the like. The communication unit 510 is connected to a network by wire or wirelessly. The communication unit 510 may be communicably connected to the orchestrator 100, the controller 200, the SLG 300, and the game server 400 via a network. The communication unit 510 can transmit and receive information via a network.

(Control Unit 520)

The control unit 520 is a controller. The control unit 520 uses, for example, a RAM or the like as a work area, and is realized by a processor such as a CPU or an MPU that executes various programs stored in a storage device inside the user device 500. Further, the control unit 520 includes, for example, an ASIC, an FPGA, it may be realized by an integrated circuit such as a GPGPU.

As illustrated in FIG. 8, the control unit 520 includes a request unit 521, a change unit 522, and an application main body 523, and realizes or executes functions and actions of information processing described below. The one or more processors of the user device 500 may implement the functions of the respective controllers in the control unit 520 by executing instructions stored in the one or more memories of the user device 500. The internal configuration of the control unit 520 is not limited to the configuration illustrated in FIG. 8, and the internal configuration of the control unit 520 may be another configuration that performs information processing described later. For example, the request unit 521 may perform all or a part of information processing described later with respect to a unit other than the request unit 521.

(Request Unit 521)

The request unit 521 has a matching request function. At the start of the application, a request unit 521 requests the game server 400 to match the user with the opponent of the user.

(Change Unit 522)

The change unit 522 has a setting value change function. After the edge server is newly deployed, a change unit 522 receives a new connection destination from the central game server. The change unit 522 changes the setting value of the connection destination of the application main body 523, which will be described later, according to the new connection destination.

(Application Main Body 523)

The application main body 523 is an application (for example, a match game) installed in the user device 500. The application main body 523 communicates with a data processing unit 425 of the game server 400. The application main body 523 calculates data to be processed on the client side when the game is executed.

### 9. Example of Delay Control Processing

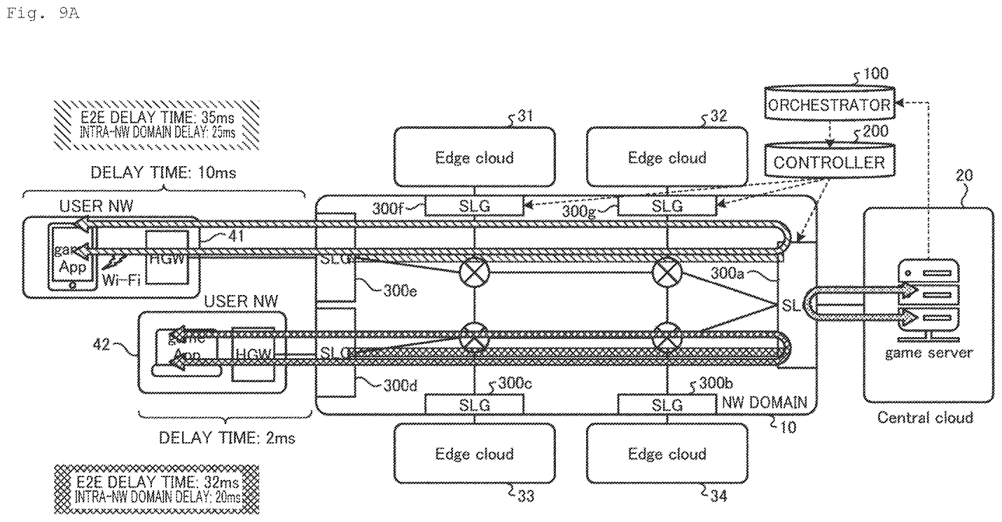

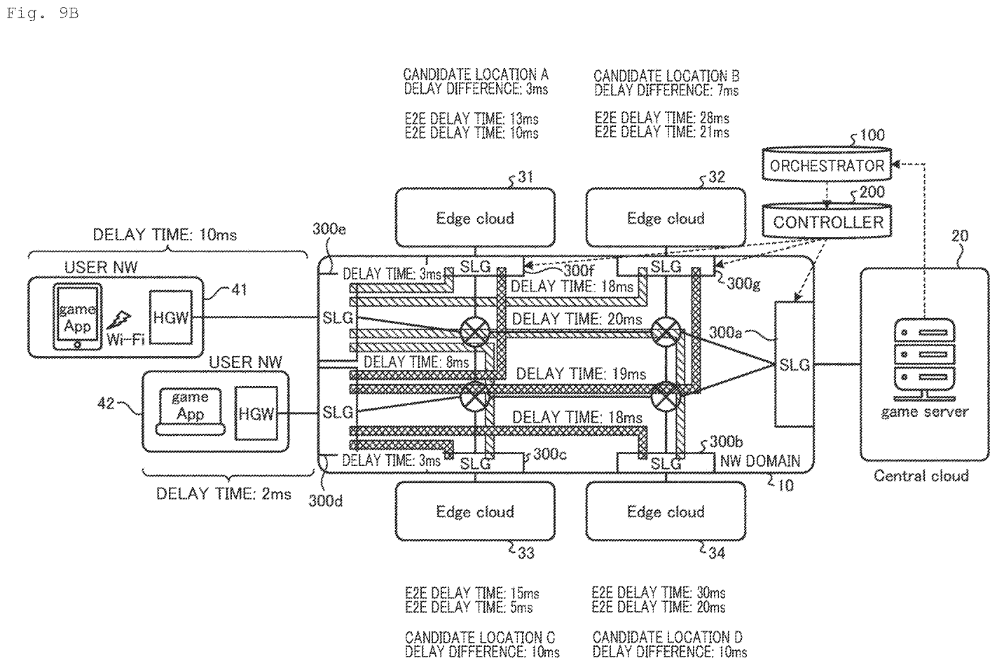

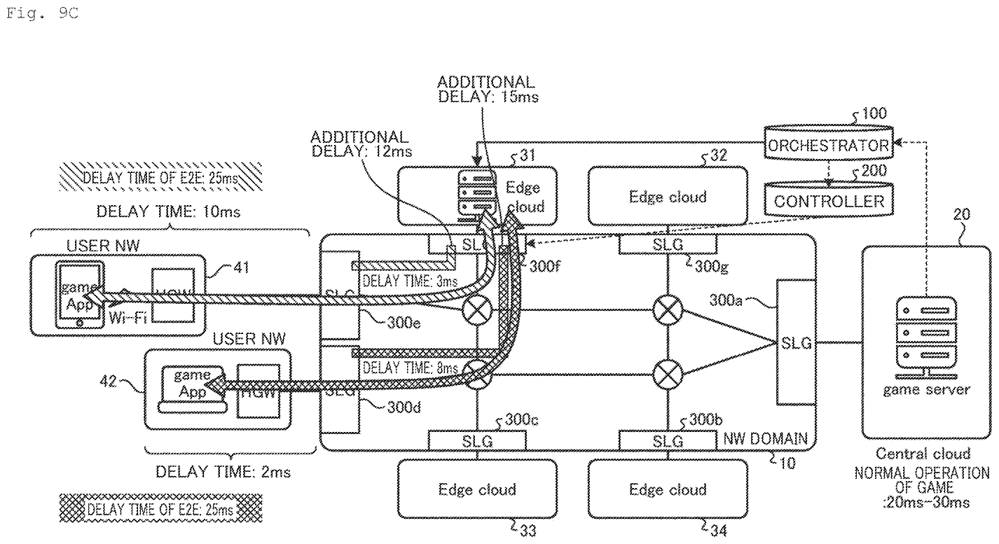

In the above description, the outline of the delay control processing has been described with reference to FIGS. 3A, 3B, and 3C. Here, an example of the delay control processing will be described in more detail with reference to FIGS. 9A, 9B, and 9C.

FIGS. 9A, 9B, and 9C are explanatory diagrams showing an example of delay control processing according to the embodiment.

Referring to FIG. 9A, first, a user of a user NW 41 and a user of a user NW 43 start a game application. For example, a first user and a second user start a game from an application. A user device 500 of each user is connected to a game server of a central cloud 20. The game server starts matching between the player and the opponent of the player.

The SLG 300 measures a delay in the NW domain 10. Then, the SLG 300 acquires delay information between the SLG and the SLG in the NW domain 10.

Then, the game server of the central cloud 20 instructs the SLG 300a to measure the delay time of the E2E via the orchestrator 100.

The SLG 300a is an SLG in the vicinity of the game server of the central cloud 20. The SLG 300a measures the delay time of the E2E by using ping to the user device 500, ping to the game server, or the like.

Next, the SLG 300a compares the delay time between the SLG and the SLG in the acquired NW domain 10 with the measured delay time of the E2E to obtain the delay time of the user section (between the SLG and the game application). The SLG 300a acquires a delay time of a user NW (that is, a user section) based on a difference between a delay time between the SLG and the SLG in the NW domain 10 and a measured delay time of the E2E.

In the example of FIG. 9A, the E2E delay time of the user NW 41 is 35 ms. The intra-NW domain delay of the user NW 41 is 25 ms. Therefore, the delay time of the section of the user NW 41 is 10 ms.

In the example of FIG. 9A, the E2E delay time of the user NW 42 is 32 ms. In addition, the intra-NW domain delay of the user NW 42 is 30 ms. Therefore, the delay time of the section of the user NW 42 is 2 ms.

Referring to FIG. 9B, the orchestrator 100 (e.g., the reception unit 121) then refers to delay information between the SLG 300 in the vicinity of the user and the SLG in the vicinity of the candidate location of the edge cloud. For example, the orchestrator 100 acquires delay information from the SLG 300 via the controller 200. Then, the orchestrator 100 (for example, the calculation unit 123) calculates an assumed value of the E2E delay time in a case where the game server is deployed to each candidate location (the edge cloud 31, the edge cloud 32, the edge cloud 33, and the edge cloud 34).

For example, the SLG 300 measures a delay amount between the SLG 300 of a candidate location of the edge cloud and the SLG in the vicinity of the user. The SLG 300 measures the E2E delay time by adding the measured delay amount to the delay amount of the user section. The SLG 300 provides the measured E2E delay time to the orchestrator 100 as delay information between the SLG 300 in the vicinity of the user and the SLG in the vicinity of the candidate location of the edge cloud. For example, the SLG 300 notifies the orchestrator 100 of the delay information via the controller 200.

Then, the orchestrator 100 (for example, the location unit 124) calculates a difference among a plurality of E2E delay times for each user. Then, the orchestrator 100 selects a candidate location having the smallest difference. In the example of FIG. 9B, the delay difference 3 ms is the smallest delay difference among the plurality of delay differences. Therefore, the orchestrator 100 selects the edge cloud 31 as a candidate location.

For example, the orchestrator 100 selects a candidate location having a delay time within a range in which a game normally operates from candidate location of edge cloud. Then, the orchestrator 100 calculates a difference between the respective delay times.

Referring to FIG. 9C, the orchestrator 100 (e.g., the location unit 124) then deploys the game server to the edge cloud 31.

In the example of FIG. 9C, the edge cloud 31 is an edge cloud in which the delay of E2E becomes the fairest. In this way, the orchestrator 100 selects an edge cloud in which the delay of the E2E becomes the fairest, and deploys the game server to the selected edge cloud. For example, the orchestrator 100 deploys the game server to an edge cloud having the smallest difference in delay time among the plurality of edge clouds.

Next, the game server on the central cloud 20 instructs the application of each user to change the setting value of the connection destination to a new deployed game server via the orchestrator 100.

For example, an IP address addressed to a new game server is transmitted to each application via an orchestrator 100 and a game server on a central cloud 20. As a result, the new setting value is reflected on the setting of each application. Then, each user connects to the game server of the edge cloud 31. Specifically, each application starts communication with a game server of the edge cloud.

Then, the game server of the edge cloud 31 instructs the orchestrator 100 to register a new flow.

Then, an orchestrator 100 (for example, a registration unit 125) registers 5-tuples information in a table management unit 331 of an SLG 300f in the vicinity of the edge cloud 31 via a controller.

Thereafter, the orchestrator 100 (for example, a giving unit 126) makes the delay time of the E2E within a range (20 ms to 30 ms in the example of FIG. 9C) in which the application normally operates, the value of the delay control unit 323 of the SLG 300f is changed. For example, the orchestrator 100 instructs an SLG 300f in the vicinity of a game server on the edge cloud 31 to impart delay within a range where the game operates normally to the packet. Thus, the orchestrator 100 can unify the delay time of the E2E. In the example of FIG. 9C, the delay time of the E2E of each user is adjusted to 25 ms.

### 10. Flowchart of Delay Control Processing

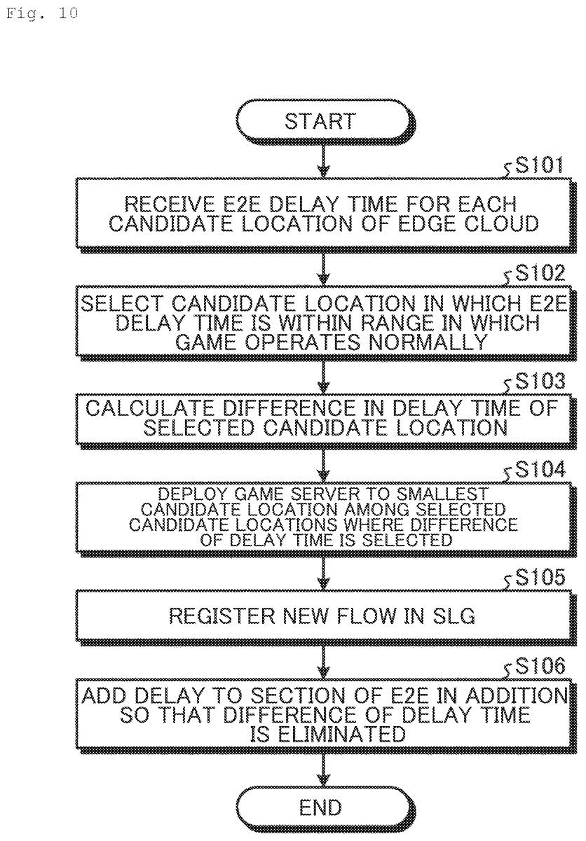

Next, a flowchart of an example of the delay control processing will be described with reference to FIG. 10. An example of delay control processing includes processing for eliminating a delay difference while suppressing delay.

FIG. 10 is a flowchart showing an example of processing executed by the orchestrator 100 according to the embodiment for eliminating a delay difference while suppressing a delay.

As shown in FIG. 10, first, a reception unit 121 of the orchestrator 100 receives the E2E delay time for each candidate location of the edge cloud (step S101). The reception unit 121 receives, for example, the E2E delay time from the controller 200.

Then, a selection unit 122 of the orchestrator 100 selects a candidate location in which the E2E delay time is within a range in which the game operates normally (step S102).

Next, a calculation unit 123 of the orchestrator 100 calculates a difference in delay time of the selected candidate location (step S103).

Next, the location unit 124 of the orchestrator 100 deploys the game server to the smallest candidate location among the candidate locations where the difference of the delay time is selected (step S104).

Next, the registration unit 125 of the orchestrator 100 registers a new flow in the SLG in response to the deployment of the game server (step S105).

Next, a giving unit 126 of the orchestrator 100 gives delay to the section of the E2E in addition so that the difference of the delay time is eliminated (step S106).

### 11. Other Embodiments

The delay control system 1 according to the above-mentioned embodiment may be implemented in various different forms other than the above-mentioned embodiment. Therefore, another embodiment of the delay control system 1 will be described below.

[11-1. Delay Control when the Delay Time Changes During the Service Use]

In this section, the processing performed by the orchestrator 100 when the delay time changes during the service use will be described. For example, if the delay increases and the delay is outside the range where the game operates normally, orchestrator 100 may adjust the additional delay again. For example, when the delay is within a range in which the game normally operates, the orchestrator 100 can adjust the additional delay again.

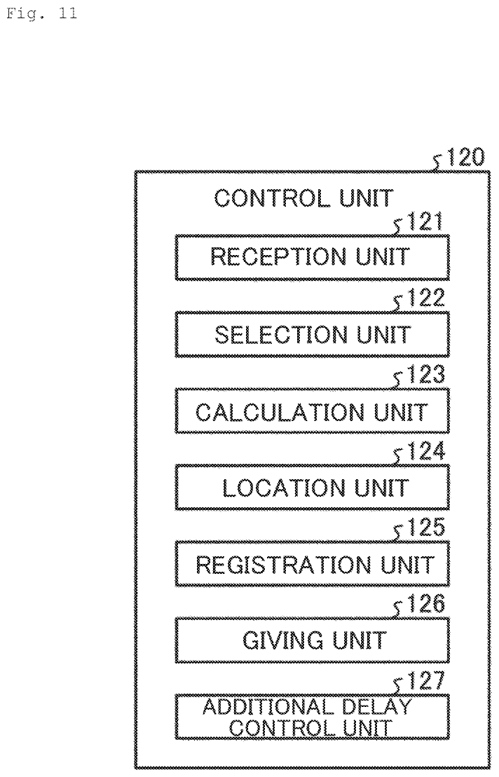

FIG. 11 is a diagram showing another example of a configuration of the orchestrator according to the present embodiment. As in the case of the above-described embodiment, the control unit 120 includes a reception unit 121, a selection unit 122, a calculation unit 123, a location unit 124, a registration unit 125, and a giving unit 126. Here, redundant description is omitted. In another example of the configuration, the control unit 120 has an additional delay control unit 127. An additional delay control unit 127 adjusts the additional delay when the delay increases during the use of the service.

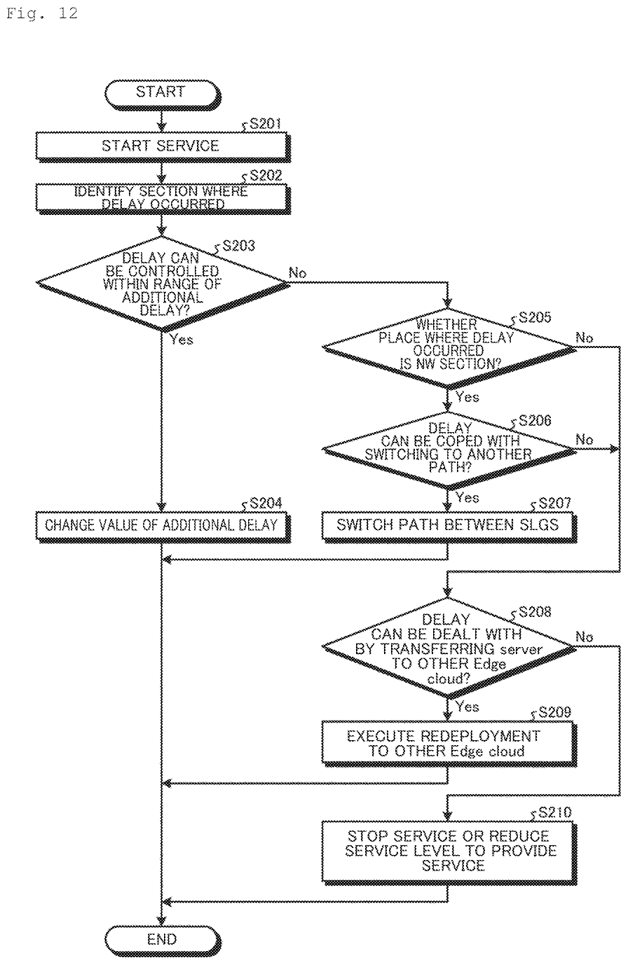

FIG. 12 is a flowchart showing an example of a procedure of the additional delay control processing according to the embodiment. In the example shown in FIG. 12, it is assumed that the game is out of the range in which the game operates normally.

As shown in FIG. 12, first, the additional delay control unit 127 starts service (step S201).

Then, an additional delay control unit 127 identifies a section where delay occurred (step S202).

Next, the additional delay control unit 127 determines whether the delay can be controlled within the range of the additional delay (step S203). For example, if the added additional delay is 15 ms and the increased delay is 15 ms or less (e.g., +10 ms), the additional delay control unit 127 may control the delay by reducing the additional delay (e.g., by changing the additional delay from 15 ms to 5 ms).

In the step S203, when it is determined that the delay can be controlled within the range of the additional delay (step S203: Yes), an additional delay control unit 127 changes the value of the additional delay (step S204).

In the step S203, when it is determined that the delay cannot be controlled within the range of the additional delay (step S203: No), the additional delay control unit 127 determines whether a location where the delay occurred is a NW section (step S205).

In the step S205, when it is determined that the location where the delay occurred is the NW section (step S205: Yes), the additional delay control unit 127 determines whether the delay can be coped with by switching to another path (step S206).

In a step S206, when it is determined that the delay can be coped with by switching to another path (step S206: Yes), the additional delay control unit 127 switches a path between SLGs (step S207).

In the step S205, when it is determined that the location where the delay occurred is not the NW section (step S205: No), the additional delay control unit 127 determines whether the delay can be dealt with by relocating a server to another edge cloud (step S208).

In the step S206, when it is determined that the delay cannot be coped with by switching to another path (step S206: No), the processing step shifts to a step S208.

In the step S208, when it is determined that the delay can be dealt with by relocating the server to the other edge cloud (step S208: Yes), the additional delay control unit 127 executes redeployment to the other edge cloud (step S209).

In the step S208, when it is determined that the delay cannot be dealt with by relocating the server to another edge cloud (step S208: No), the additional delay control unit 127 stops the service or reduces the service level to provide the service (step S210).

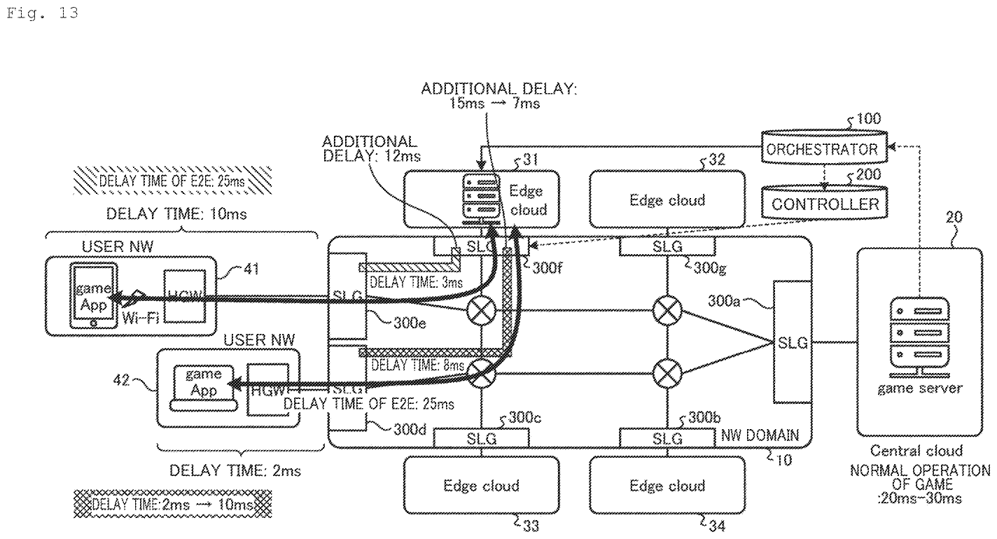

FIG. 13 is an explanatory diagram showing an example of the additional delay control processing according to the embodiment. In the example of FIG. 13, it is assumed that the delay is within a range in which the game normally operates.

An additional delay control unit 127 always acquires the delay time of the E2E and the delay time in the NW domain 10 even during service. When the delay occurs in the section somewhere in E2E, the additional delay control unit 127 controls the value of the additional delay to ensure fairness of the delay time in E2E. The additional delay control unit 127 performs such control within a delay time range in which the game normally operates.

In the example of FIG. 13, the delay time of the user NW 42 changes from 2 ms to 10 ms. Then, an additional delay control unit 127 changes the additional delay to the user NW 42 from 15 ms to 7 ms.

### [11-2. Execution Entity of Delay Control Processing by Orchestrator]

The controller 200 and the SLG 300 may perform part of the processing performed by the orchestrator 100 in the above embodiments. As described above with reference to FIG. 1, delay control system 1 includes a controller 200 and an SLG 300. The controller 200 and the SLG 300 include a reception unit 121, a selection unit 122, a calculation unit 123, a location unit 124, a part of the information processing described above may be shared with respect to the registration unit 125 and the giving unit 126.

### 12. Effects

As described above, the orchestrator 100 according to the embodiment includes the location unit 124 and the giving unit 126.

In the orchestrator 100 according to an embodiment, the location unit 124 locates a location unit locates a server in anyone of a plurality of edge clouds on the basis of a plurality of delay differences, respectively corresponding to the plurality of the edge clouds having each delay difference and assumed if the server located in each of the edge clouds, that are each a difference between delay from the server to a first client and delay from the server to a second client. Further, in the orchestrator 100 according to the embodiment, the giving unit 126 gives a delay to at least one of the first client or the second client such that the delay from the server located by the location unit 124 to the first client and the delay from the server located by the location unit 124 to the second client are the same.

Furthermore, in the orchestrator 100 according to an embodiment, the location unit 124 locates the server in one of the plurality of the edge clouds so as to minimize a difference between a delay from the server to the first client and a delay from the server to the second client as a location of the server on the basis of the plurality of the delay differences.

Furthermore, in the orchestrator 100 according to an embodiment, the giving unit 126 gives delay to at least one of a packet between the server located and the first client or a packet between the server located and the second client as imparting delay to at least one of the first client and the second client.

Furthermore, in the orchestrator 100 according to an embodiment, the giving unit 126 gives a delay to at least one of the first client or the second client within a range in which applications installed in the first client and the second client normally operate

Furthermore, in the orchestrator 100 according to an embodiment, further comprising an additional delay control unit 127 that adjusts the added delay such that, when at least one of the delay from the server to the first client that is located or the delay from the server to the second client that is located increases during operation of the application, the delay from the server to the first client that is located and the delay from the server to the second client that is located are within a range in which the application normally operates.

The orchestrator 100 can ensure fairness of delay by the above-described each processing.

### 13. Others

Also, out of the pieces of processing that have been described in the embodiment, some pieces of processing that have been described as being executed automatically may also be executed manually. Alternatively, all or part of processes described as being manually performed can be automatically performed by known methods. In addition, information including the processing procedure, specific name, various data and parameters that are shown in the above documents and drawings may be arbitrarily changed unless otherwise described. For example, the various information shown in each figure is not limited to the information shown in the figure.

In addition, the components of each of the devices illustrated in the figure are illustrated as functional concept and do not necessarily need to be configured physically as illustrated in the figure. In other words, the specific aspects of distribution and integration of the devices are not limited to those illustrated in the drawings, all or part of the components may be distributed or integrated functionally or physically in desired units depending on various kinds of loads and states of use.

For example, a part or all of the storage unit 130 illustrated in FIG. 4 may be held in a storage server or the like instead of being held by the orchestrator 100. In this case, the orchestrator 100 acquires various kinds of information such as resources by accessing the storage server.

### 14. Hardware Configuration

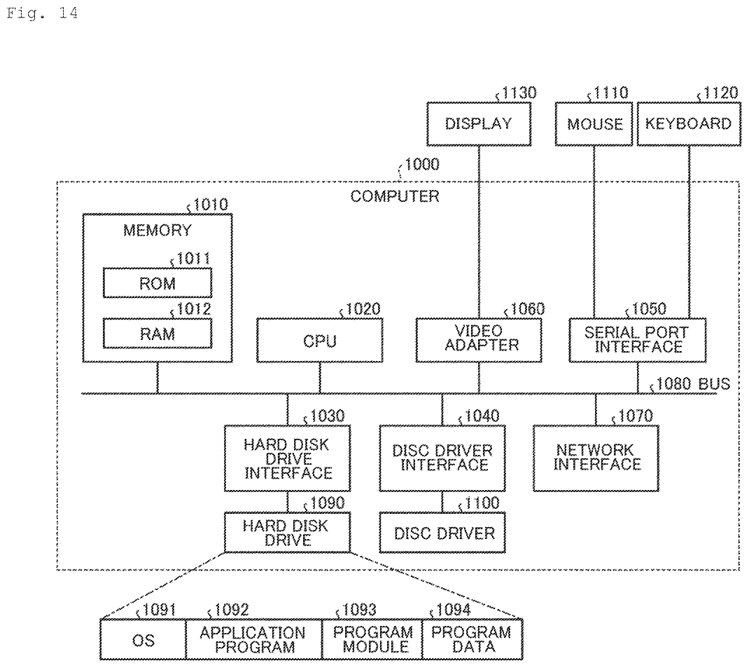

FIG. 14 is a diagram showing an example of a hardware configuration. The orchestrator 100, the controller 200, the SLG 300, the game server 400, and the user device 500 according to the above-described embodiment are implemented by a computer 1000 having a configuration as illustrated in FIG. 14, for example.

FIG. 14 illustrates an example of a computer in which the orchestrator 100, the controller 200, the SLG 300, the game server 400, and the user device 500 are implemented by executing a program. A computer 1000 includes, e.g., a memory 1010 and a CPU 1020. The computer 1000 also includes a hard disk drive interface 1030, a disc drive interface 1040, a serial port interface 1050, a video adapter 1060, and a network interface 1070. Each of these units is connected by a bus 1080.

The memory 1010 includes a ROM (Read Only Memory) 1011 and a RAM 1012. The ROM 1011 stores, for example, a boot program such as a Basic Input Output System (BIOS). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, the program that defines each process of the orchestrator 100, the controller 200, the SLG 300, the game server 400, or the user device 500 is implemented as a program module 1093 in which codes executable by the computer 1000 are described. The program module 1093 is stored in, for example, the hard disk drive 1090. For example, the program module 1093 for executing the same processing as the functional configuration in the orchestrator 100, the controller 200, the SLG 300, the game server 400, or the user device 500 is stored in the hard disk drive 1090. The hard disk drive 1090 may be replaced with a solid state drive (SSD).

Furthermore, the setting data used in the processing of the above-described embodiment is stored, for example, in the memory 1010 or the hard disk drive 1090 as the program data 1094. Then, the CPU 1020 reads the program module 1093 and the program data 1094 stored in the memory 1010 or the hard disk drive 1090 into the RAM 1012 and executes them as necessary.

Note that the program module 1093 and program data 1094 are not limited to being stored in the hard disk drive 1090, and may also be stored in, for example, a removable storage medium and read out by the CPU 1020 via the disk drive 1100, etc. Alternatively, the program module 1093 and program data 1094 may be stored in other computers connected via a network (LAN, WAN, and the like). Then, the program module 1093 and program data 1094 may be read out from the other computers via the network interface 1070 by the CPU 1020.

While some of the embodiments of the present application have been described in detail with reference to the drawings, these are illustrative and the present invention is not limited to specific examples. The features described herein can be implemented in various modifications, improvements based on the knowledge of those skilled in the art, including aspects described in the column of aspects for implementing the invention.

The “unit (unit)” described above can be replaced with a module, a section, a means, a circuit, or the like. For example, the giving unit can be replaced with a giving module or a giving circuit.

### REFERENCE SIGNS LIST

1 Delay control system
100 Orchestrator
110 Communication unit
120 Control unit
121 Reception unit
122 Selection unit
123 Calculation unit
124 Location unit
125 Registration unit
126 Giving unit
127 Additional delay control unit
130 Storage unit
131 Resource storage unit
200 Controller
210 Communication unit
220 Control unit
221 Management unit
222 Reception unit
223 Transmission unit
300 SLG
310 Communication unit
320 Control unit
321 Acquisition unit
322 Transmission unit
323 Delay control unit
324 Path control unit
325 Allocation unit
330 Storage unit
331 Table management unit
400 Game server
410 Communication unit
420 Control unit
421 First instruction unit
422 Acquisition unit
423 Matching unit
424 API unit
425 Data processing unit
426 Second instruction unit
500 User device
510 Communication unit
520 Control unit
521 Request unit
522 Change unit
523 Application main body

1. A delay control device, comprising:
a processor; and
a memory device storing instructions that, when executed by the processor, configure the processor to:
locate a server in anyone of a plurality of edge clouds on the basis of a plurality of delay differences, respectively corresponding to the plurality of the edge clouds having each delay difference and assumed if the server located in each of the edge clouds, that are each a difference between delay from the server to a first client and delay from the server to a second client; and
provide a delay to at least one of the first client and the second client so that the delay from the server to the first client and the delay from the server to the second client become the same.

2. The delay control device according to claim 1, wherein the processor is configured to locate the server in one of the plurality of the edge clouds so as to minimize a difference between a delay from the server to the first client and a delay from the server to the second client as a location of the server on the basis of the plurality of the delay differences.

3. The delay control device according to claim 1, wherein the processor is configured to provide a delay to at least one of a packet between the server located and the first client or a packet between the server located and the second client as imparting delay to at least one of the first client and the second client.

4. The delay control device according to claim 1, wherein the processor is configured to provide a delay to at least one of the first client or the second client within a range in which applications installed in the first client and the second client normally operate.

5. The delay control device according to claim 4, the processor is further configured to adjust the added delay such that, when at least one of the delay from the server to the first client that is located or the delay from the server to the second client that is located increases during operation of an application, the delay from the server to the first client that is located and the delay from the server to the second client that is located are within a range in which the application normally operates.

6. A delay control method, which is executed by a computer, comprising:
locating a server in anyone of a plurality of edge clouds on the basis of a plurality of delay differences, respectively corresponding to the plurality of the edge clouds having each delay difference and assumed if the server located in each of the edge clouds, that are each a difference between delay from the server to a first client and delay from the server to a second client; and
providing a delay to at least one of the first client and the second client so that the delay from the server to the first client and the delay from the server to the second client become the same.

7. A non-transitory computer readable medium storing a program, wherein executing of the program causes a computer to perform operations comprising:
locating a server in anyone of a plurality of edge clouds on the basis of a plurality of delay differences, respectively corresponding to the plurality of the edge clouds having each delay difference and assumed if the server located in each of the edge clouds, that are each a difference between delay from the server to a first client and delay from the server to a second client; and
providing a delay to at least one of the first client and the second client so that the delay from the server to the first client and the delay from the server to the second client become the same.

8. The delay control device according to claim 2, wherein the processor is configured to provide a delay to at least one of a packet between the server located and the first client or a packet between the server located and the second client as imparting delay to at least one of the first client and the second client.

9. The delay control device according to claim 2, wherein the processor is configured to provide a delay to at least one of the first client or the second client within a range in which applications installed in the first client and the second client normally operate.

10. The delay control device according to claim 3, wherein the processor is configured to provide a delay to at least one of the first client or the second client within a range in which applications installed in the first client and the second client normally operate.
